(19) United States
(12) Patent Application Publication
(10) Pub. No.: US 2024/0070591 A1
(43) Pub. Date: Feb. 29, 2024

(54) METHOD FOR PROVIDING COMPANY ASSESSMENT SERVICE THROUGH NETWORK, AND MANAGEMENT SERVER USED THEREFOR

(71) Applicant: Ki Wook KWON, Daejeon (KR)

(72) Inventor: Ki Wook KWON, Daejeon (KR)

(21) Appl. No.: 18/270,046

(22) PCT Filed: Jan. 18, 2022
(86) PCT No.: PCT/KR2022/000887

§ 371 Date: Jun. 28, 2023

(30) Foreign Application Priority Data
Jan. 28, 2021 (KR) 10-2021-0012609

(51) Int. Cl. G06Q 10/0639

(52) U.S. Cl. CPC G06Q 10/0639

(57) ABSTRACT

Proposed are a method for providing a company assessment service through a network and a management server used therefor. The method is implemented through processes of, by a management server, receiving a company assessment request from a user terminal, transmitting survey items corresponding to the company assessment request to the user terminal, receiving response information of a user on the survey items from the user terminal, and generating a company assessment report based on the response information of a user. According to the method, it is possible to contribute to creating social values by sharing the organizational assessment model (OAM), which may be easily used by companies and developed based on academically verified knowledge, with other companies.

### TECHNICAL FIELD

The present invention relates to a method for providing a company assessment service through a network and a management server used therefor, and more particularly, to a method for providing a company assessment service through a network, that can contribute to creating social values by sharing an organizational assessment model (OAM), a human capital assessment model (HCAM), and an organizational culture assessment model (OCAM), which may be easily used by companies and developed based on academically verified knowledge, with other companies, and can contribute to creating social values by sharing results derived through utilization of the organizational assessment and human capital assessment models with individual companies in the form of a report, as well as can contribute to creating social values by assessing the type, focus, and considerations of individual companies' corporate culture through utilization of a competitive value model and sharing data resulted from the assessment with other companies, and a management server used therefor.

### BACKGROUND ART

In the case of many Korean companies (especially, small and medium businesses), there is an increasing interest in identifying present status of internal and external management conditions through assessment of corporate capabilities and human capital, and thus strategically using organizational operations and human resources based on the identified situation. However, in addition to resource limitations, it is difficult to access useful knowledge and models related thereto.

Further, two important resources required for the company to continuously create values in a rapidly changing business environment are financial resources and human resources. In particular, corporate members are sources of competitive advantage in the era of the Fourth Industrial Revolution, and creation of achievements through their motivation, active participation, and creative/innovative activities is required. To this end, an understanding of human capital, which is the source of competitive advantage, should be preceded first.

In this regard, many Korean companies are making efforts to adapt to the changing environment through assessment of the human capital and strategically use the organizational management and human resources. However, in addition to the resource limitations, it is difficult to access valid and useful knowledge and models related thereto.

In addition, many Korean companies are seeking a diversion in their strategic direction and a change in personnel management systems in order to adapt to the changing environment. However, to this end, in addition to changes in the system and structure, changes in the cultural values of the company recognized by members should be undertaken. Although the interest in corporate culture assessment is increasing, most companies are not able to continue the actual assessment due to limited knowledge and resources required for corporate culture assessment.

### SUMMARY OF INVENTION

### Problems to be Solved by Invention

Accordingly, an object of the present invention is to provide a method for providing a company assessment service through a network, that can contribute to creating social values by sharing an organizational assessment model (OAM), a human capital assessment model (HCAM), and an organizational culture assessment model (OCAM), which may be easily used by companies and developed based on academically verified knowledge, with other companies, and a management server used therefor.

In addition, another object of the present invention is to provide a method for providing a company assessment service through a network, that can contribute to creating social values by sharing results derived through utilization of the organizational assessment and human capital assessment models with individual companies in the form of a report, and a management server used therefor.

Further, another object of the present invention is to provide a method for providing a company assessment service through a network, that can contribute to creating social values by assessing the type, focus, and considerations of individual companies' corporate culture through utilization of the organizational culture assessment model using a competitive value model and sharing data resulted from the assessment with other companies, and a management server used therefor.

### Means for Solving Problems

To achieve the above objects, according to an aspect of the present invention, there is provided a method for providing a company assessment service through a network, the method including: (a) receiving, by a management server, a company assessment request from a user terminal; (b) transmitting, by the management server, survey items corresponding to the company assessment request to the user terminal; (c) receiving, by the management server, response information of a user on the survey items from the user terminal; and (d) generating, by the management server, a company assessment report based on the response information of a user. Preferably, the company assessment request includes selection information on a company assessment type.

In addition, the company assessment type may include an organizational assessment, a human capital assessment, and an organizational culture assessment.

According to another aspect of the present invention, there is provided a management server including: a reception unit configured to receive a company assessment request from a user terminal; and a transmission unit configured to transmit survey items corresponding to the company assessment request to the user terminal, wherein the reception unit receives response information of a user on the survey items from the user terminal, and the management server further includes a generation unit configured to generate a company assessment report based on the response information of a user.

Preferably, the company assessment request includes selection information on a company assessment type.

In addition, the company assessment type may include an organizational assessment, a human capital assessment, and an organizational culture assessment.

### Advantageous Effects

According to the present invention, it is possible to contribute to creating social values by sharing the organizational assessment model (OAM), which may be easily used by companies and developed based on academically verified knowledge, with other companies.

In addition, according to the present invention, it is possible to contribute to creating social values by sharing results derived through utilization of the human capital assessment model (HCAM), which may be easily used by companies and developed based on academically verified knowledge, with individual companies in the form of a report.

Further, according to the present invention, it is possible to contribute to creating social values by assessing the type, focus, and considerations of individual companies' corporate culture through utilization of the organizational culture assessment model (OCAM) using the competitive value model, which may be easily used by companies and developed based on academically verified knowledge, and sharing data resulted from the assessment with other companies.

### BRIEF DESCRIPTION OF DRAWINGS

FIG. 1 is a view illustrating a configuration of a system for providing a company assessment service through a network according to an embodiment of the present invention;

FIG. 2 is a functional block diagram illustrating a structure of a management server which executes a method for providing a company assessment service through a network according to an embodiment of the present invention;

FIG. 3 is a flow chart illustrating signals in an execution process of the method for providing a company assessment service through a network according to an embodiment of the present invention;

FIG. 4 is a diagram illustrating a company assessment type selection screen in the company assessment service through a network according to an embodiment of the present invention; and

FIGS. 5 and 6 are diagrams illustrating a part of contents of a human capital assessment report in the company assessment service through a network according to an embodiment of the present invention, respectively.

### MODE FOR CARRYING OUT INVENTION

Hereinafter, the present invention will be described with reference to the accompanying drawings in detail. Referring to the drawings, wherein like reference characters designate like or corresponding parts throughout the several views. In the embodiments of the present invention, the publicly known functions and configurations that are judged to be able to make the purport of the present invention unnecessarily obscure will not be described.

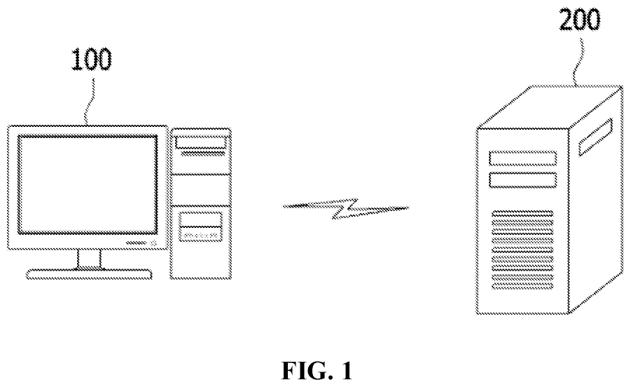

FIG. 1 is a view illustrating a configuration of a system for providing a company assessment service through a network according to an embodiment of the present invention. Referring to FIG. 1, the system for providing a company assessment service through a network according to an embodiment of the present invention includes a user terminal 100 and a management server 200.

The user terminal 100 is a communication terminal such as a PC, smart phone, or smart pad owned by a user such as a representative of a company, a personnel manager, or an employee who receives the company assessment service through a network according to an embodiment of the present invention.

The management server 200 is a server installed and operated by a business operator who provides the company assessment service through a network according to an embodiment of the present invention. The management server 200 receives a company assessment request including selection information on a company assessment type from the user terminal 100, transmits survey items corresponding to the company assessment request to the user terminal 100, receives response information of a user on the survey items, and generates a company assessment report based on the user's response information.

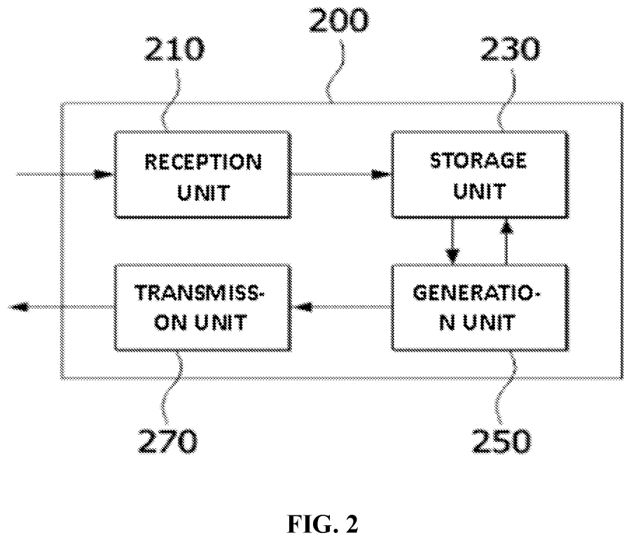

FIG. 2 is a functional block diagram illustrating a structure of the management server 200 which executes a method for providing a company assessment service through a network according to an embodiment of the present invention. Referring to FIG. 2, the management server 200 which executes the method for providing a company assessment service through a network according to an embodiment of the present invention includes a reception unit 210, a storage unit 230, a generation unit 250, and a transmission unit 270.

The reception unit 210 is configured to receive a company assessment request from the user terminal 100, and receive response information of a user on the survey items from the user terminal 100.

The generation unit 250 is configured to generate a company assessment report based on the response information, and the transmission unit 270 is configured to transmit the survey items corresponding to the company assessment request to the user terminal 100 and transmit the generated company assessment report to the user terminal 100.

Meanwhile, various information received from the reception unit 210, various information generated by the generation unit 250, and various information transmitted from the transmission unit 270 are cumulatively stored in the storage unit 230.

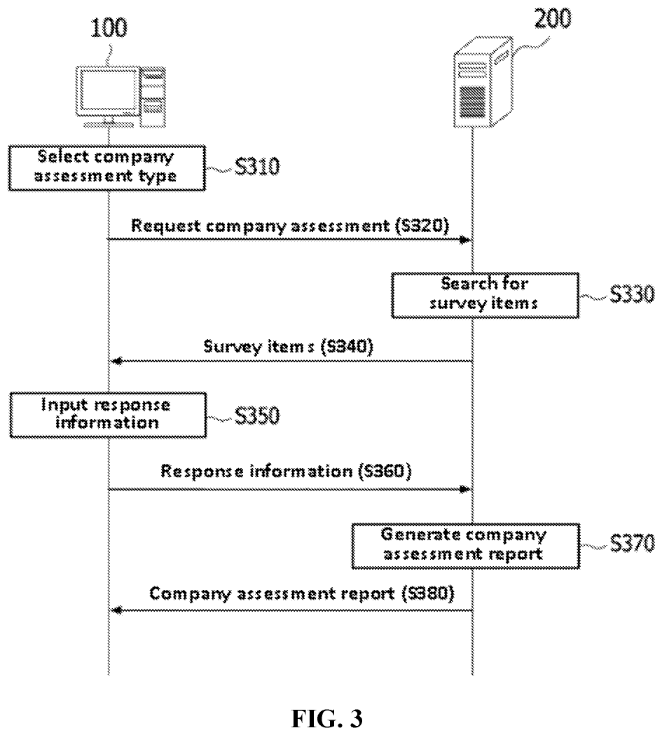

FIG. 3 is a flow chart illustrating signals in an execution process of the method for providing a company assessment service through a network according to an embodiment of the present invention. Hereinafter, the execution process of the method for providing a company assessment service through a network according to an embodiment of the present invention will be described with reference to FIGS. 1 to 3.

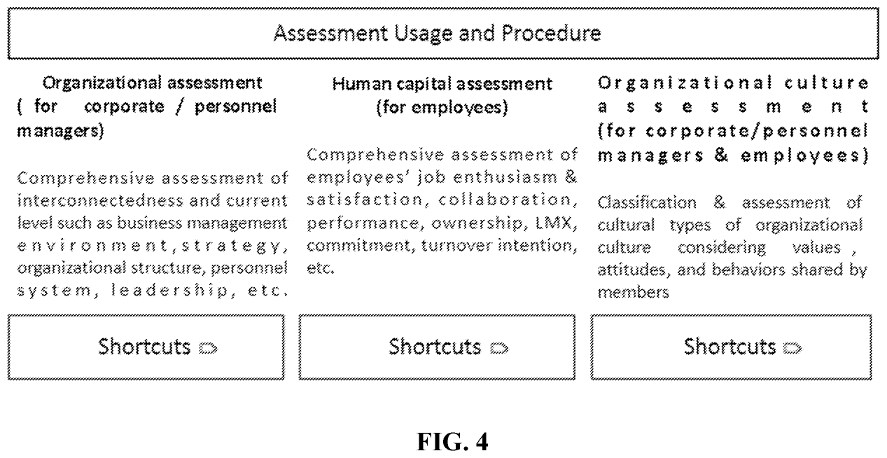

First, as a user accesses the management server 200 through the user terminal 100, company assessment type information including organizational assessment, human capital assessment, and organizational culture assessment is displayed on a screen of the user terminal 100 as shown in FIG. 4. Then, the user selects type information desired for assessment among the organizational assessment, human capital assessment, and organizational culture assessment through the user terminal 100 (S310).

Thereby, the reception unit 210 of the management server 200 receives a company assessment request including the company assessment type information selected by the user from the user terminal 100 (S320).

Meanwhile, survey item information corresponding to each company assessment type information is stored in the storage unit 230 of the management server 200, and the management server 200 searches for the survey items corresponding to the company assessment type information received from the user terminal 100 through the storage unit 230 (S330).

The transmission unit 270 of the management server 200 sequentially transmits the searched survey items from the user terminal 100 (S340), and the user who has confirmed the survey items through the screen of the user terminal 100 inputs response information for each survey item through the user terminal 100 (S350).

When the user inputs the response information for each survey item through the user terminal 100, the reception unit 210 of the management server 200 sequentially receives the response information for each survey item from the user terminal 100, and the received response information is sequentially cumulatively stored in the storage unit 230 of the management server 200 (S360).

As the user's response to each survey item is completed, the generation unit 250 of the management server 200 generates a company assessment report based on the user's response information cumulatively stored in the storage unit 230 (S370).

Specifically, when the user selects the organizational assessment in the above-described step S310, the generation unit 250 of the management server 200 generates an organizational assessment report based on the user's response information, when the user selects the human capital assessment, the generation unit 250 of the management server 200 generates a human capital assessment report based on the user's response information, and when the user selects the organizational culture assessment, the generation unit 250 of the management server 200 generates an organizational culture assessment report based on the user's response information.

Hereinafter, a process of generating the company assessment report based on the user's response information on survey items in the generation unit 250 of the management server 200 will be described in detail.

Generation Principle of Organizational Assessment Report

The company's organizational assessment report may include an environmental uncertainty index, and the environmental uncertainty index may be an average value (or total value) of the calculated scores for each of the following items.
1) Environmental uncertainty
2) Environmental complexity
3) Environmental dynamism

Hereinafter, a score calculation method for each of the above items will be described.

1) Environmental Uncertainty Score

The generation unit 250 of the management server 200 may calculate the environmental uncertainty score as an average value (or total value) of user's answer scores (1. Strongly disagree/2. Disagree/3. Neutral (i.e., neither agree nor disagree)/4. Agree/5. Strongly agree) to the following survey items.

It is difficult to predict how the business environment of our company will change in the future.

The business environment of our company is uncertain.

2) Environmental Complexity Score

The generation unit 250 of the management server 200 may measure the environmental complexity score by user's answer scores (1. Strongly disagree/2. Disagree/3. Neutral/4. Agree/5. Strongly agree) to the following survey item.

Our company needs to work/interact with a large number of stakeholders (suppliers, distribution companies, consumers, etc.) for successful management.

3) Environmental Dynamism Score

The generation unit 250 of the management server 200 may measure the environmental dynamism score by user's answer scores (1. Strongly disagree/2. Disagree/3. Neutral/4. Agree/5. Strongly agree) to the following survey item.

The business environment of our company is rapidly changing.

In addition, the company's organizational assessment report may include a strategic direction & capability index, and the strategic direction & capability index may be an average value (or total value) of the calculated scores for each of the following items.
1) Clear direction
2) Leadership
3) Human capital
4) Social capital

Hereinafter, a score calculation method for each of the above items will be described.

1) Clear Direction Score

The generation unit 250 of the management server 200 may calculate the clear direction score as an average value (or total value) of user's answer scores (1. Strongly disagree/2. Disagree/3. Neutral/4. Agree/5. Strongly agree) to the following survey items.

Our company has a clear direction for the future.

Our company has a clear strategic direction.

Our company's employees clearly understand the company's future/strategic direction.

2) Leadership Score

The generation unit 250 of the management server 200 may calculate the leadership score as an average value (or total value) of user's answer scores (1. Strongly disagree/2. Disagree/3. Neutral/4. Agree/5. Strongly agree) to the following survey items.

CEO tries to predict what will happen in the future.

CEO is highly engaged, energetic, passionate and motivated.

CEO plans and acts based on future goals.

CEO has a clear understanding of the direction the company is heading.

3) Human Capital Score

The generation unit 250 of the management server 200 may calculate the human capital score as an average value (or total value) of user's answer scores (1. Strongly disagree/2. Disagree/3. Neutral/4. Agree/5. Strongly agree) to the following survey items.

Our company's employees have a high level of technological capability.

Within the industry to which our company belongs, our company's employees are highly regarded.

4) Social Capital Score

The generation unit 250 of the management server 200 may calculate the social capital score as an average value (or total value) of user's answer scores (1. Strongly disagree/2. Disagree/3. Neutral/4. Agree/5. Strongly agree) to the following survey items.

Our company's employees are good at cooperating with other employees to assess and solve problems.

Our company's employees communicate and exchange ideas with employees working in other departments of our company.

Our company's employees form partnerships with consumers, suppliers, and partners to solve problems.

In addition, the company's organizational assessment report may include an organizational structure flexibility index, and the organizational structure flexibility index may be an average value (or total value) of the calculated scores for each of the following items.
1) Formalization
2) Centralization
3) Segmentation
4) Information sharing

Hereinafter, a score calculation method for each of the above items will be described.

1) Formalization Score

The generation unit 250 of the management server 200 may measure the formalization score by user's answer scores (1. Strongly disagree/2. Disagree/3. Neutral/4. Agree/5. Strongly agree) to the following survey item.

In our company, most of the things that departments, teams, and employees have to do are officially documented.

2) Centralization Score

The generation unit 250 of the management server 200 may measure the centralization score by user's answer scores (1. Strongly disagree/2. Disagree/3. Neutral/4. Agree/5. Strongly agree) to the following survey item.

In our company, most decisions are made at the top management level.

3) Segmentation Score

The generation unit 250 of the management server 200 may measure the segmentation score by user's answer scores (1. Strongly disagree/2. Disagree/3. Neutral/4. Agree/5. Strongly agree) to the following survey item.

In our company, roles and responsibilities (R&R) are subdivided too much.

4) Information Sharing Scores

The generation unit 250 of the management server 200 may calculate the information sharing score as an average value (or total value) of user's answer scores (1. Strongly disagree/2. Disagree/3. Neutral/4. Agree/5. Strongly agree) to the following survey items.

In our company, information sharing between sections, departments, and teams is carried out smoothly.

In our company, information sharing is carried out smoothly vertically from the top floor to field departments/employees.

Further, the company's organizational assessment report may include an organizational process effectiveness index, and the organizational process effectiveness index may be an average value (or total value) of the calculated scores for each of the following items.
1) Collaboration (cooperation)
2) Organizational fairness climate
3) Productivity

Hereinafter, a score calculation method for each of the above items will be described.

1) Collaboration (Cooperation) Score

The generation unit 250 of the management server 200 may calculate the collaboration (cooperation) score as an average value (or total value) of user's answer scores (1. Strongly disagree/2. Disagree/3. Neutral/4. Agree/5. Strongly agree) to the following survey items.

In this company, the level of cooperation between employees is high.

Employees are willing to sacrifice their own interests for the good of the team (group).

In this company, the level of sharing among employees is high.

2) Organizational Fairness Climate Score

The generation unit 250 of the management server 200 may measure the organizational fairness climate score by user's answer scores (1. Strongly disagree/2. Disagree/3. Neutral/4. Agree/5. Strongly agree) to the following survey item.

Employees of this company think that this company is generally fair.

3) Productivity Score

The generation unit 250 of the management server 200 may measure the productivity score as a value obtained by taking the natural logarithm of user's answer scores (total sales/total number of employees, sales per person) to the following question items.
What was your company's total sales last year? ( ) million won
How many employees did you have in your company last year? ( ) people

Further, the company's organizational assessment report may include an appropriateness index of the personnel system, and the appropriateness index of the personnel system may be an average value (or total value) of the calculated scores for each of the following items.
1) Investment in recruitment
2) Fair & systematic evaluation
3) Compensation for performance
4) Opportunity and investment in training development
5) Participation in decision-making
6) Flexible job design
7) Open communication
8) Core manpower management
9) Personnel system analytics: Degree to which objective data is analyzed/utilized and reflected in decision-making when operating the personnel system.

Hereinafter, a score calculation method for each of the above items will be described.

1) Investment Score in Recruitment

The generation unit 250 of the management server 200 may calculate the investment score in recruitment as an average value (or total value) of user's answer scores (1. Strongly disagree/2. Disagree/3. Neutral/4. Agree/5. Strongly agree) to the following survey items.

We use a variety of selection and screening systems to select excellent employees.

We invest a lot of money and time in the recruitment process to select excellent personnel.

We invest heavily in education/training for employees.

2) Fair & Systematic Evaluation Score

The generation unit 250 of the management server 200 may calculate the fair & systematic evaluation score as an average value (or total value) of user's answer scores (1. Strongly disagree/2. Disagree/3. Neutral/4. Agree/5. Strongly agree) to the following survey items.

We have a formal evaluation system for effectively evaluating the performance and abilities of our employees.

We evaluate the work performance of employees based on objective and quantitative goals.

3) Compensation Score for Performance

The generation unit 250 of the management server 200 may calculate the compensation score for performance as an average value (or total value) of user's answer scores (1. Strongly disagree/2. Disagree/3. Neutral/4. Agree/5. Strongly agree) to the following survey items.

Directly link employee evaluation results to individual wages and promotions.

Salary increases are determined depending on the performance and ability of employees.

Even within the same position, there is a wide wage gap (differential width) between the employees depending on the performance and ability.

Many employees are benefiting from a system that can distribute collective performance, such as company profits.

4) Opportunity and Investment Score in Training Development

The generation unit 250 of the management server 200 may calculate the opportunity and investment score as an average value (or total value) of user's answer scores (1. Strongly disagree/2. Disagree/3. Neutral/4. Agree/5. Strongly agree) to the following survey items.

We provide various education/training programs to our employees.

We invest heavily in education/training for employees.

5) Participation Score in Decision-Making

The generation unit 250 of the management server 200 may calculate the participation score in decision-making as an average value (or total value) of user's answer scores (1. Strongly disagree/2. Disagree/3. Neutral/4. Agree/5. Strongly agree) to the following survey items.

Employees participate widely in decision-making and problem-solving in matters related to their duties and work environment.

Our company actively shares various information related to management strategy, financial performance and organization operation with employees.

6) Flexible Job Design Score

The generation unit 250 of the management server 200 may calculate the flexible job design score as an average value (or total value) of user's answer scores (1. Strongly disagree/2. Disagree/3. Neutral/4. Agree/5. Strongly agree) to the following survey items.

Employees are given a lot of discretion in performing their duties.

Employees can flexibly adjust their working hours or select one from several work styles.

7) Open Communication Score

The generation unit 250 of the management server 200 may calculate the open communication score as an average value (or total value) of user's answer scores (1. Strongly disagree/2. Disagree/3. Neutral/4. Agree/5. Strongly agree) to the following survey items.

We are implementing various systems to listen to employees' complaints and opinions.

Our company actively shares various information related to management strategy, financial performance and organization operation with employees.

8) Core Manpower Management Score

The generation unit 250 of the management server 200 may calculate the core manpower management score as an average value (or total value) of user's answer scores (1. Strongly disagree/2. Disagree/3. Neutral/4. Agree/5. Strongly agree) to the following survey items.

We operate a differentiated personnel system for core manpower.

We have a personnel system for selecting, training, motivating, and maintaining the core manpower.

9) Personnel System Analytic Score

The generation unit 250 of the management server 200 may calculate the personnel system analytic score as an average value (or total value) of user's answer scores (1. Strongly disagree/2. Disagree/3. Neutral/4. Agree/5. Strongly agree) to the following survey items.

We use (statistics and evidence-based) analytics in personnel-related activity and decision-making.

We practically consider/calculate financial effects (return on investment (ROI), etc.) of personnel management in personnel-related decision-making, and utilize results thereof.

Further, the company's organizational assessment report may include an internalization index of the organizational structure & personnel system, and the internalization index of the organizational structure & personnel system may be an average value (or total value) of the calculated scores for each of the following items.
1) Internalization of structure
2) Internalization of personnel system

Hereinafter, a score calculation method for each of the above items will be described.

1) Internalization Score of Structure

The generation unit 250 of the management server 200 may calculate the internalization score of structure as an average value (or total value) of user's answer scores (1. Strongly disagree/2. Disagree/3. Neutral/4. Agree/5. Strongly agree) to the following survey items.

Employees of this company believe that the current system, organizational structure and operation are working well.

Employees of this company are satisfied with the current system, organizational structure and operation.

Employees of this company want the current systems, organizational structure and operations to be maintained.

2) Internalization Score of Personnel System

The generation unit 250 of the management server 200 may calculate the internalization score of personnel system as an average value (or total value) of user's answer scores (1. Strongly disagree/2. Disagree/3. Neutral/4. Agree/5. Strongly agree) to the following survey items.
Employees of this company believe that the current personnel system is valuable.
Employees of this company are satisfied with the current personnel system.
Employees of this company want the current personnel system to be maintained.

In addition, the company's organizational assessment report may include an innovation & performance index, and the innovation & performance index may be an average value (or total value) of the calculated scores for each of the following items.
Organizational innovation
Employee turnover rate
High performer turnover rate
Corporate performance

Hereinafter, a score calculation method for each of the above items will be described.

1) Organizational Innovation Score

The generation unit 250 of the management server 200 may calculate the organizational innovation score as an average value (or total value) of user's answer scores (1. Strongly disagree/2. Disagree/3. Neutral/4. Agree/5. Strongly agree) to the following survey items.
Our company is responding to changes in the environment.
Our company performs innovative management in planning (designing) procedures and process control systems (terms).
Our company develops new technologies.
Our company incorporates technologies into new products.

2) Employee Turnover Rate

The generation unit 250 of the management server 200 may calculate the employee turnover rate using user answers (the number of turnover employees among all regular employees÷the number of total regular employees) to the following survey items.
How many full-time employees were there last year? ( ) people
How many employees among all regular employees have changed jobs last year? ( ) people

3) High Performer Turnover Rate

The generation unit 250 of the management server 200 may calculate the high performer turnover rate based on the user's answers (the number of high performers (top 20%) who voluntarily have changed jobs among all regular employees÷20% of the total number of regular employees) to the following survey items.
How many full-time employees were there last year? ( ) people
How many high performers (top 20% performers) among all regular employees have voluntarily changed jobs last year? ( ) people

4) Corporate Performance Score

The generation unit 250 of the management server 200 may calculate the company performance score using user's answers (net income per person=net income÷total number of employees; total return on asset=net income÷total assets; total return on equity=net income÷total equity) to the following survey items.
How many employees were there in your company last year? ( ) people
What was your company's total assets last year? ( ) million won
What was your company's total equity last year? ( ) million won

Generation Principle of Human Capital Assessment Report

The company's human capital assessment report may include an index of relational factors between employees, leaders and organizations, and the corresponding index may be an average value (or total value) of the calculated scores for each of the following items.
1) Leader-member exchange (comprehensive level of quality of exchange relationship between superior and subordinate)
2) CEO & organizational trust (level of trust in CEO and organization)
3) Organization support recognition (degree to which employees recognize that the organization is interested in and supporting the employees)

Hereinafter, a score calculation method for each of the above items will be described.

1) Leader-Member Exchange Score

The generation unit 250 of the management server 200 may calculate the leader-member exchange score as an average value (or total value) of user's answer scores (1. Strongly disagree/2. Disagree/3. Neutral/4. Agree/5. Strongly agree) to the following survey items.

My boss is well aware of my job-related problems and requirements.

I have a good working relationship with my boss.

2) CEO & Organizational Trust Score

The generation unit 250 of the management server 200 may calculate the CEO & organizational trust score as an average value (or total value) of user's answer scores (1. Strongly disagree/2. Disagree/3. Neutral/4. Agree/5. Strongly agree) to the following survey items.

I trust the words and actions of the CEO/top management of our company.

I think our company's CEO/top management is presenting the company's vision correctly.

I believe that our company will make a wise decision for the future of the organization.

Our company's employees trust the company.

3) Organization Support Recognition Score

The generation unit 250 of the management server 200 may calculate the organizational support recognition score as an average value (or total value) of user's answer scores (1. Strongly disagree/2. Disagree/3. Neutral/4. Agree/5. Strongly agree) to the following survey items.

Our company sincerely cares for my growth and development.

Our company actively helps me when I am in trouble.

Our company supports me in what I need to improve my work performance.

The company's human capital assessment report may include an organizational fairness index felt by employees, and the corresponding index may be an average value (or total value) of the calculated scores for each of the following items.

Overall fairness (recognition that the organization is treating its employees fairly overall)

Distributive fairness (recognition that the organizations are fairly rewarding individuals for their performance (results))

Procedural fairness (extent to which the employees recognize that the organization is fair in the process of determining individual results [performance evaluation, compensation, work assignment, etc.])

Hereinafter, a score calculation method for each of the above items will be described.

1) Overall Fairness Score

The generation unit 250 of the management server 200 may calculate the overall fairness score as an average value (or total value) of user's answer scores (1. Strongly disagree/2. Disagree/3. Neutral/4. Agree/5. Strongly agree) to the following survey items.

Our company is generally fair.

Our company's employees think that the company is fair.

2) Distributive Fairness Score

The generation unit 250 of the management server 200 may calculate the distributive fairness score as an average value (or total value) of user's answer scores (1. Strongly disagree/2. Disagree/3. Neutral/4. Agree/5. Strongly agree) to the following survey items.
I receive compensation commensurate with the work performance I have achieved.
I think the reward for my performance is fair.

3) Procedural Fairness Score

The generation unit 250 of the management server 200 may calculate the procedural fairness score as an average value (or total value) of user's answer scores (1. Strongly disagree/2. Disagree/3. Neutral/4. Agree/5. Strongly agree) to the following survey items.

I believe that the company is procedurally fair in decision-making related to evaluation, compensation, and job division.

I can express my thoughts and opinions in the company's decision-making process related to the evaluation, compensation, and job division.

The company's human capital assessment report may include an index of a degree of internalization of the personnel system, and the corresponding index may be an average value (or total value) of the calculated scores for each of the following items.
1) Acceptability (degree to which employees accept the personnel system)
2) Objectivity (degree to which employees recognize the personnel system as objective)
3) Internalization of system (degree to which employees accept the personnel system as valuable are satisfied with it and hope it to be maintained)

Hereinafter, a score calculation method for each of the above items will be described.

1) Acceptability Score

The generation unit 250 of the management server 200 may calculate the acceptability score as an average value (or total value) of user's answer scores (1. Strongly disagree/2. Disagree/3. Neutral/4. Agree/5. Strongly agree) to the following survey items.
I consider that results of my job performance evaluation are acceptable.
I consider that results related to my compensation are acceptable.

2) Objectivity Score

The generation unit 250 of the management server 200 may calculate the objectivity score as an average value (or total value) of user's answer scores (1. Strongly disagree/2. Disagree/3. Neutral/4. Agree/5. Strongly agree) to the following survey items.

I believe that my job performance evaluation is made objectively.

I believe that my compensation-related decision is made objectively.

3) Internalization Score of System

The generation unit 250 of the management server 200 may calculate the internalization score of system as an average value (or total value) of user's answer scores (1. Strongly disagree/2. Disagree/3. Neutral/4. Agree/5. Strongly agree) to the following survey items.
I hope that our company's personnel system (evaluation, compensation, promotion, training, etc.) will be maintained.
I think that our company's personnel system (evaluation, compensation, promotion, training, etc.) is valuable.
I am satisfied with our company's personnel system (evaluation, compensation, promotion, training, etc.).

The company's human capital assessment report may include an index of cooperation and trust between members, and the corresponding index may be an average value (or total value) of the calculated scores for each of the following items.
1) Cooperation (extent to which employees cooperate with each other)
2) Group efficacy (extent to which employees recognize that a group, such as a team, organization, etc., to which they belong can achieve their goals)

Hereinafter, a score calculation method for each of the above items will be described.

1) Cooperation Score

The generation unit 250 of the management server 200 may calculate the cooperation score as an average value (or total value) of user's answer scores (1. Strongly disagree/2. Disagree/3. Neutral/4. Agree/5. Strongly agree) to the following survey items.

The level of cooperation between employees is high in this company.

Employees are willing to sacrifice their own interests for the good of the team (group).

2) Group Efficacy

The generation unit 250 of the management server 200 may calculate the group efficacy as an average value (or total value) of user's answer scores (1. Strongly disagree/2. Disagree/3. Neutral/4. Agree/5. Strongly agree) to the following survey items.
Our company's employees are highly capable.
Our company is generally effective.

The company's human capital assessment report may include an employee's positive attitude and behavior index, and the corresponding index may be an average value (or total value) of the calculated scores for each of the following items.
1) Organizational commitment (degree to which employees identify with and are attached to the organization to which they belong)
2) Job enthusiasm (state in which employees are psychologically immersed in performing their duties and are proactive in their works)
3) Psychological ownership (psychological state in which employees feel that the organization to which they belong is ‘mine’ through intimacy and bonding in their feelings about the organization)

Hereinafter, a score calculation method for each of the above items will be described.

1) Organizational Commitment Score

The generation unit 250 of the management server 200 may calculate the organization commitment score as an average value (or total value) of user's answer scores (1. Strongly disagree/2. Disagree/3. Neutral/4. Agree/5. Strongly agree) to the following survey items.

I feel as if our company's problems are my problems.

I feel a high sense of belonging to the current organization.

2) Job Enthusiasm Score

The generation unit 250 of the management server 200 may calculate the job enthusiasm score as an average value (or total value) of user's answer scores (1. Strongly disagree/2. Disagree/3. Neutral/4. Agree/5. Strongly agree) to the following survey items.
I am passionate about my job.
At work, I am immersed in my duties.

3) Psychological Ownership Score

The generation unit 250 of the management server 200 may calculate the psychological ownership score as an average value (or total value) of user's answer scores (1. Strongly disagree/2. Disagree/3. Neutral/4. Agree/5. Strongly agree) to the following survey items.
I feel a very high degree of ownership in this company.
I feel a very high degree of ownership of the work I do.

The company's human capital assessment report may include an employee's negative attitude and behavior index, and the corresponding index may be an average value (or total value) of the calculated scores for each of the following items.
1) Turnover intention (employee's intention to leave the organization to which he or she belongs)
2) Deviant behavior (voluntary behavior that violates important norms of the organization and threatens the well-being of the organization and its members)

Hereinafter, a score calculation method for each of the above items will be described.

1) Turnover Intention Score

The generation unit 250 of the management server 200 may calculate the turnover intention score as an average value (or total value) of user's answer scores (1. Strongly disagree/2. Disagree/3. Neutral/4. Agree/5. Strongly agree) to the following survey items.

I will find a new job within a year.

I often think about changing jobs.

2) Deviant Behavior Score

The generation unit 250 of the management server 200 may calculate the deviant behavior score as an average value (or total value) of user's answer scores (1. Strongly disagree/2. Disagree/3. Neutral/4. Agree/5. Strongly agree) to the following survey items.
In our company, employees hardly put in any effort when they are working.
In our company, employees take company property without permission.
In our company, employees behave rudely to other employees.

The company's human capital assessment report may include an employee's work life satisfaction & happiness index, and the corresponding index may be an average value (or total value) of the calculated scores for each of the following items.
1) Job satisfaction (degree to which employees are satisfied with their jobs)
2) Happiness (degree to which employees recognize that they are happy in the organization)

Hereinafter, a score calculation method for each of the above items will be described.

1) Job Satisfaction Score

The generation unit 250 of the management server 200 may calculate the job satisfaction score as an average value (or total value) of user's answer scores (1. Strongly disagree/2. Disagree/3. Neutral/4. Agree/5. Strongly agree) to the following survey item.
I am generally satisfied with my job.

2) Happiness Score

The generation unit 250 of the management server 200 may calculate the happiness score as an average value (or total value) of user's answer scores (1. Strongly disagree/2. Disagree/3. Neutral/4. Agree/5. Strongly agree) to the following survey items.
Generally, I feel happy in this company.
Generally, I feel good in this company.

In addition, the generation unit 250 of the management server 200 may calculate an average value for all employees of the average values of the respective evaluation indices for each employee, which are calculated based on the response information input by the employees belonging to a specific company through their user terminal 100 in the above-described step S350.

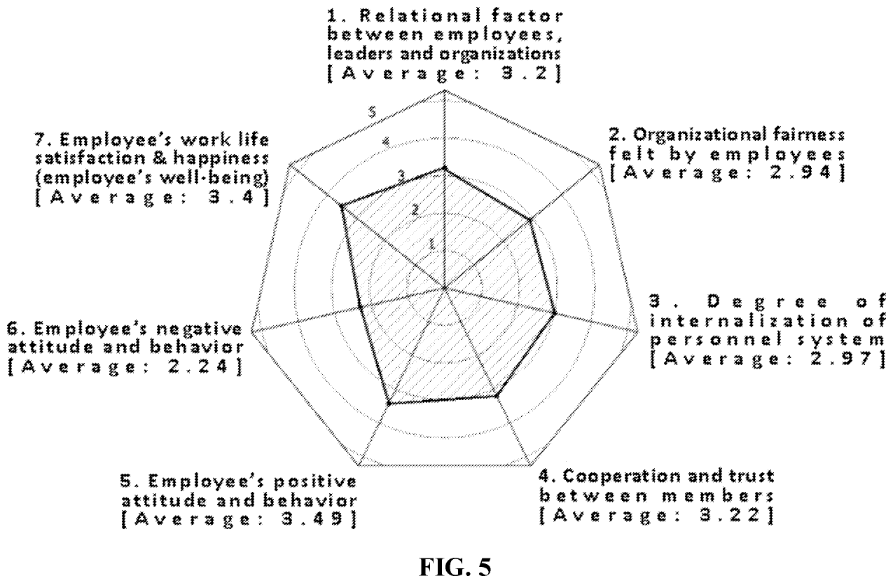

In addition, in carrying out the present invention, the generation unit 250 of the management server 200 may generate human capital assessment reports by employee type such as education, gender, position, age, and job performance level by individually calculating an average value of the average values of the respective evaluation indices for each employee, which are calculated based on the response information input by the employees belonging to the specific company through their user terminal 100 for some employees (for example: some employees extracted by final academic background such as college graduates and high school graduates, etc.; some employees extracted by gender such as male employees, female employees, etc.; some employees extracted by position such as employees, assistant manager, manager, deputy manager, general manager or higher, etc.; some employees extracted by age such as those in their 20s, 30s, 40s and 50 years old, etc.; some employees extracted by job performance level such as top 20% in performance evaluation (A), top 20%-40% in performance evaluation (B), 41%-60% in performance evaluation (C), 61%-80% in performance evaluation (D), bottom 20% in performance evaluation (E), etc.), which are extracted according to a predetermined criterion among all employees as shown in FIG. 5.

In carrying out the present invention, after the above-described step S360 and before the above-described step S370, the management server 200 may: receive a request for generating human capital assessment reports including manager's selection information on at least one of the education, gender, position, age, and job performance level from a manager terminal owned by a manager such as a representative of a company, etc.; generate human capital assessment reports by employee type such as education, gender, position, age, and job performance level, as described above, based on selection information received from the manager terminal; and transmit the generated human capital assessment reports to the manager terminal.

Through this, the manager such as the representative of a company can receive the human capital assessment reports that have been generated by classifying the employees belonging to the company by education, gender, position, age, and job performance level. Therefore, results obtained by mutually comparing the human capital assessment reports by education, gender, position, age, and job performance level may be used for human capital management.

Meanwhile, to this end, in the above-described step S350, it is preferable that the user first inputs personal information such as his/her final education, gender, position, age, job performance level, etc. into the user terminal 100 before entering the response information, so that the management server 200 receives personal information from the user terminal 100, and thereby the user's response information is stored in the storage unit 230 of the management server 200 together in association with the personal information of each user.

In addition, in carrying out the present invention, the generation unit 250 of the management server 200 may calculate importance & satisfaction matrix assessment results based on answer scores (1. Very low/2. Low/3. Medium/4. High/5. Very high) to the degree that the user considers important for each of the following survey items, and user's satisfaction answer scores (1. Very low/2. Low/3. Medium/4. High/5. Very high) to the same survey items.
1. Organizational culture and pursued value
2. Growth and development of the company
3. Close personal relationships with co-workers
4. Opportunities for self-improvement
5. Employment guarantee
6. Work autonomy (identity)
7. Work opportunities that provide a feeling of being challenged and accomplished
8. Promotion/elevation
9. Relationship with boss
10. Salary level
11. Work-life balance (quality of life)
12. Differential compensation according to performance
13. Discriminated compensation according to job value/ability

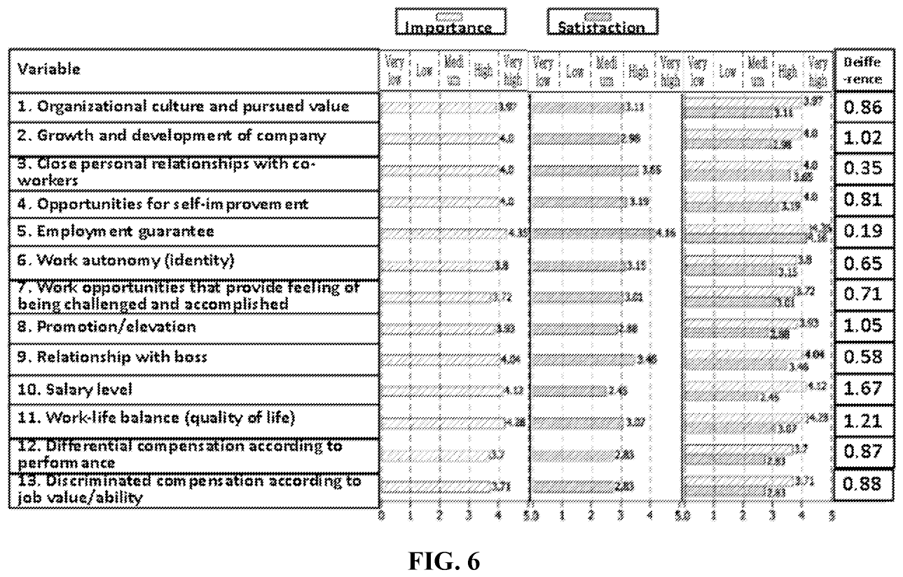

Further, in carrying out the present invention, the generation unit 250 of the management server 200 may calculate an average value of the importance answer scores of all employees for each item, and calculate an average value of the satisfaction answer scores of all employees for each item, then generate a human capital assessment report including the comparison results of both average values, as shown in FIG. 6.

Furthermore, in carrying out the present invention, the generation unit 250 of the management server 200 may calculate an average value of the importance response scores some employees (for example: some employees extracted by final academic background such as college graduates and high school graduates, etc.; some employees extracted by gender such as male employees, female employees, etc.; some employees extracted by position such as employees, assistant manager, manager, deputy manager, general manager or higher, etc.; some employees extracted by age such as those in their 20s, 30s, 40s and 50 years old, etc.; some employees extracted by job performance level such as top 20% in performance evaluation (A), top 20%-40% in performance evaluation (B), 41%-60% in performance evaluation (C), 61%-80% in performance evaluation (D), bottom 20% in performance evaluation (E), etc.), which are extracted according to a predetermined criterion among all employees, for each item, and calculate an average value of the satisfaction answer scores of some employees, which are equally extracted, for each item, then generate a human capital assessment report including the comparison results of both average values.

In carrying out the present invention, after the above-described step S360 and before the above-described step S370, the management server 200 may: receive a request for generating human capital assessment reports including manager's selection information on at least one of the education, gender, position, age, and job performance level from the manager terminal owned by the manager such as a representative of a company, etc.; generate human capital assessment reports as described above for the some employees extracted as described above from among all employees based on the selection information received from the manager terminal.

Generation Principle of Organizational Culture Assessment Report

The organizational culture assessment report may include a kinship culture index, and the generation unit 250 of the management server 200 may: calculate a kinship culture index (current) as an average value (or total value) of user's answer scores (1. Strongly disagree/2. Disagree/3. Somewhat disagree/4. Neutral/5. Somewhat agree/6. Agree/7. Strongly agree) to user's current status relating to the following survey items; and calculate a kinship culture index (preference) as an average value (or total value) of user's answer scores (1. Strongly disagree/2. Disagree/3. Somewhat disagree/4. Neutral/5. Somewhat agree/6. Agree/7. Strongly agree) to user's preference status relating to the following survey items; then calculate a difference between the kinship culture index (current) and the kinship culture index (preference) to calculate a demand index for improvement to the kinship culture.

The organization has a strong sense of humanity and it is like an extension of the family. In addition, employees share a lot about themselves with each other.

Leaders of the organization typically act as advisors or sponsors.

Organizational management values teamwork, consensus, and participation.

Force that unites the organization is loyalty and mutual trust. Commitment to the organization is strong.

Organizational strategy emphasizes development of human resources, high trust, openness, and continuous participation.

Success criteria of the organization are development of human resources, teamwork, commitment of members, and respect for people.

In addition, the organizational culture assessment report may include an innovation culture index, and the generation unit 250 of the management server 200 may: calculate an innovation culture index (current) as an average value (or total value) of user's answer scores (1. Strongly disagree/2. Disagree/3. Somewhat disagree/4. Neutral/5. Somewhat agree/6. Agree/7. Strongly agree) to user's current status relating to the following survey items; and calculate an innovation culture index (preference) as an average value (or total value) of user's answer scores (1. Strongly disagree/2. Disagree/3. Somewhat disagree/4. Neutral/5. Somewhat agree/6. Agree/7. Strongly agree) to user's preference status relating to the following survey items; then calculate a difference between the innovation culture index (current) and the innovation culture index (preference) to calculate a demand index for improvement to the innovation culture.

The organization is a very dynamic and entrepreneurial place. In addition, employees are willing to take risks.

Leaders of the organization typically practice innovation, exploration, and entrepreneurship.

Organizational management values individual challenge, innovation, freedom and individuality.

Force that unites the organization is commitment to innovation and development. Emphasis is placed on taking one step ahead.

Organizational strategy emphasizes acquiring new resources or creating challenges. It values trying new things and exploring opportunities.

Success criteria of the organization are to create unique and new products and services. It is important to be an innovator and the greatest leader.

Further, the organizational culture assessment report may include a market culture index, and the generation unit 250 of the management server 200 may: calculate a market culture index (current) as an average value (or total value) of user's answer scores (1. Strongly disagree/2. Disagree/3. Somewhat disagree/4. Neutral/5. Somewhat agree/6. Agree/7. Strongly agree) to user's current status relating to the following survey items; and calculate a market culture index (preference) as an average value (or total value) of user's answer scores (1. Strongly disagree/2. Disagree/3. Somewhat disagree/4. Neutral/5. Somewhat agree/6. Agree/7. Strongly agree) to user's preference status relating to the following survey items; then calculate a difference between the market culture index (current) and the market culture index (preference) to calculate a demand index for improvement to the market culture.

The organization places great importance on results and a focus on achieving performance goals. In addition, the employees are very competitive and achievement oriented.

Leaders of the organization typically engage in aggressive, result- and achievement-oriented behavior.

Organizational management focuses on intense competition, multiple expectations and achievements.

Force that unites the organization is an expectation of task achievement and goal attainment.

Organizational strategy emphasizes competitive behavior and performance. It places great importance on achieving goals and winning is more important than anything else.

Success criteria of the organization are winning and having a competitive advantage. It is important to secure a competitive edge in the market.

Furthermore, the organizational culture assessment report may include a hierarchical culture index, and the generation unit 250 of the management server 200 may: calculate a hierarchical culture index (current) as an average value (or total value) of user's answer scores (1. Strongly disagree/2. Disagree/3. Somewhat disagree/4. Neutral/5. Somewhat agree/6. Agree/7. Strongly agree) to user's current status relating to the following survey items; and calculate a hierarchical culture index (preference) as an average value (or total value) of user's answer scores (1. Strongly disagree/2. Disagree/3. Somewhat disagree/4. Neutral/5. Somewhat agree/6. Agree/7. Strongly agree) to user's preference status relating to the following survey items; then calculate a difference between the hierarchical culture index (current) and the hierarchical culture index (preference) to calculate a demand index for improvement to the hierarchical culture.

The organization is a very controlled and structured place. Employees place great importance on formal procedures in handling business.
Leaders of the organization typically seek coordination, organization, and efficiency.
Organizational management emphasizes a guarantee of employee's status, organizational stability, sense of unity, and predictability.
Force that unites the organization is formal rules and guidelines. It is important to operate the organization smoothly.
Organizational strategy emphasizes continuity and stability. It places great importance on efficiency, control, and smooth operation.
The primary success criterion for an organization is efficiency improvement. The key is securing reliability in the provision of products and services, managing schedules without difficulty, and decreasing production costs.

Meanwhile, as the transmission unit 270 of the management server 200 transmits the company assessment reports generated as described above and a download link of the report to the user terminal 100, the user may use the company assessment reports (organizational assessment, human capital assessment, organization cultural assessment) provided from the management server 200 in various corporate activities (S380).

In addition, in carrying out the present invention, a program for executing the method of providing a company assessment service according to the present invention may be installed in the management server 200 according to the present invention, recorded in various computer-readable recording media, or stored in the server which transmits the corresponding program through a network.

Terms used in the present invention are used only to describe specific embodiments, and are not intended to limit the present invention. Singular expressions used herein include plural expressions unless they have definitely opposite meanings in the context. In the present application, it should be understood that term “include” or “have” indicates that a feature, a number, a step, an operation, a component, a part or the combination thereof described in the specification is present, but does not exclude a possibility of presence or addition of one or more other features, numbers, steps, operations, components, parts or combinations thereof, in advance.

While the present invention has been described with reference to the preferred embodiments and modified examples, the present invention is not limited to the above-described specific embodiments and the modified examples, and it will be understood by those skilled in the art that various modifications and variations may be made therein without departing from the scope of the present invention as defined by the appended claims, as well as these modifications and variations should not be understood separately from the technical idea and prospect of the present invention.

### INDUSTRIAL APPLICABILITY

The present invention may be applied to the fields of company organizational assessment model (OAM), human capital assessment model (HCAM) and organizational culture assessment model (OCAM), such that industrial applicability thereof may be recognized.

1. A method for providing a company assessment service through a network, the method comprising:
(a) receiving, by a management server, a company assessment request from a user terminal;
(b) transmitting, by the management server, survey items corresponding to the company assessment request to the user terminal;
(c) receiving, by the management server, response information of a user on the survey items from the user terminal; and
(d) generating, by the management server, a company assessment report based on the response information of a user.

2. The method according to claim 1, wherein the company assessment request comprises selection information on a company assessment type.

3. The method according to claim 1, wherein the company assessment type comprises an organizational assessment, a human capital assessment, and an organizational culture assessment.

4. A management server comprising:
a reception unit configured to receive a company assessment request from a user terminal; and
a transmission unit configured to transmit survey items corresponding to the company assessment request to the user terminal,
wherein the reception unit receives response information of a user on the survey items from the user terminal, and
the management server further comprises a generation unit configured to generate a company assessment report based on the response information of a user.

5. The management server according to claim 4, wherein the company assessment request comprises selection information on a company assessment type.

6. The management server according to claim 4, wherein the company assessment type comprises an organizational assessment, a human capital assessment, and an organizational culture assessment.
